(19) United States
(12) Patent Application Publication
(10) Pub. No.: US 2010/0282675 A1
(43) Pub. Date: Nov. 11, 2010

(54) SYSTEM AND METHOD FOR REVERSIBLE CATION-EXCHANGE DESALINATION

(75) Inventors: Arup K. SenGupta, Bethlehem, PA (US); Sudipta Sarkar, Bethlehem, PA (US)

Correspondence Address: Saul Ewing LLP (Harrisburg);Attn: Patent Docket Clerk, Penn National Insurance Plaza, 2 North Second Street, 7th Floor, Harrisburg, PA, 17101, US

(73) Assignee: LEHIGH UNIVERSITY, Bethlehem, PA (US)

(21) Appl. No.: 12/624,917

(22) Filed: Nov. 24, 2009

Related U.S. Application Data
(60) Provisional application No. 61/176,602, filed on May 8, 2009.

(51) Int. Cl. C02F 1/42; B01D 65/02

(52) U.S. Cl. 210/636; 210/687; 210/638; 210/198.2

(57) ABSTRACT

Desalination is accomplished by subjecting feed saline water to a cation exchanger in magnesium form where sodium and scale-forming cations are at least partially exchanged for non-scale-forming magnesium ions. This ion exchange also reduces the osmotic pressure of the solution. When the resultant solution is subjected to a pressure-driven membrane desalination process, scaling is reduced and desalinated water is efficiently produced at a lower pressure. After desalination, the concentrated waste water, which contains higher concentrations of ions such as magnesium and sodium, is used to regenerate the depleted cation exchanger back into magnesium form. This regeneration permits the process to be self-sustainable.

### CROSS-REFERENCE TO RELATED APPLICATIONS

This application claims the priority of U.S. 61/176,602 (filed on May 8, 2009), the contents of which are incorporated herein by reference.

### FIELD

This application describes a system and self-sustaining method for desalination using cation exchange to reduce osmotic pressure and reduce scale formation.

### BACKGROUND

Desalination of saline water is needed to meet increasing demands for freshwater in arid regions around the world. Common methods of desalination include physical separation of salt and water phases across a semi-permeable membrane under the influence of a chemical potential gradient, which may be effected either by application of pressure, a concentration gradient, an electrical potential, or combinations thereof. Examples of such processes include reverse osmosis (“RO”), nanofiltration (“NF”), forward osmosis (“FO”), electrodialysis (“ED”), and the like. Currently, reverse osmosis is the predominant commercially used desalination technique. See, e.g., “Desalination: A National Perspective,” National Academy of Engineering, The National Academics Press, Washington, D.C., 2008; “News: Desalination Freshens Up,” Science 313, 1088-90 (2006).

Existing desalination methods, however, suffer from a number of disadvantages. First, reverse osmosis requires high pressures in order to overcome the natural osmotic pressure of saline water. Second, precipitation of salts from the input saline solution can form deposits, i.e., scale, on osmosis membranes, thereby causing a reduction in membrane efficiency. A continuing and unmet need exists for new and improved systems and methods for effective desalination. The present invention satisfies these needs and provides other advantages.

### SUMMARY

Reversible cation-exchange membrane desalination (“RCIX-MEM”) as described herein is a novel hybrid method for desalination. This desalination method includes cation exchange followed by pressure-driven reverse osmosis or nanofiltration.

In the cation-exchange step, magnesium ions are exchanged for monovalent sodium ions, as well as di- or polyvalent cations, thereby reducing the osmotic pressure of the solution. Such replacement of cations by magnesium ions allows for higher permeate flux through osmosis membranes and improved yields of desalinated water as compared to conventional reverse osmosis processes.

The method also eliminates or reduces the scaling potential of various salts of calcium, barium, and strontium. As a further advantage over conventional desalination methods, the method can be performed without added anti-scaling agents. Scale-forming di- or polyvalent cations, such as calcium, barium, and strontium, are exchanged for equivalent ionic concentrations of magnesium ions upon passing input saline water through a bed of a cation exchange resin that is pre-saturated in magnesium form.

The concentrated reject or return solution, which is rich in magnesium, may be used to regenerate the exhausted ion exchanger and return it to the magnesium form. Thus, the process is self-sustained without requiring any external addition of regenerant chemicals.

Accordingly, in one embodiment, the invention provides a method of desalination comprising (1) at least partially exchanging cations in a feed water for magnesium ions using a reversible cation exchange process to thereby produce an effluent water having a reduced concentration of scale-forming di- or higher valent cations and a reduced osmotic pressure, and thereafter (2) treating the effluent water from the prior step with a pressure-driven process to produce a desalinated water and a waste water.

In another embodiment, the invention provides a method of manufacturing desalinated water comprising (1) providing a strong-acid cation exchange resin in magnesium form; (2) contacting a feed water with the strong-acid cation exchange resin to thereby produce an effluent water, the effluent water being at least partially enriched with magnesium cations and at least partially depleted of scale-forming cations; (3) compressing the effluent water against a first surface of a semi-permeable filter; (4) collecting a desalinated water from a second surface of the semi-permeable filter, the desalinated water having passed between the first surface and the second surface while under pressure; and (5) collecting a waste water, the waste water having not passed between the first surface and the second surface while under pressure.

In still another embodiment, the invention provides an apparatus for desalination comprising (1) a first cation exchange column comprising magnesium ions, the cation exchange column being disposed to contact a feed water comprising sodium cations to form an effluent water; and (2) a semi-permeable filter for treating the effluent water to produce a desalinated water and a waste water.

Additional features may be understood by referring to the accompanying drawings, which should be read in conjunction with the following detailed description and examples.

### DESCRIPTION OF THE DRAWINGS

FIG. 1 is a schematic illustration of a cation-exchange step in an exemplary RCIX-MEM process.

FIG. 2 illustrates the reduction in theoretical osmotic pressure of sodium chloride following passage through ion exchangers pre-saturated with divalent magnesium ions. In this example, the osmotic pressure of the solution is reduced from 25 bar to 18.7 bar upon ion exchange.

FIG. 3 schematically illustrates an exemplary RCIX-MEM desalination process delineating three major operational steps. In the first step, a cation exchanger in magnesium form exchanges sodium and divalent ions to produce a magnesium-enriched effluent. The second step includes reverse osmosis of the magnesium-enriched solution. The third step includes regeneration of the cation exchanger back into its magnesium form using the magnesium-enriched reject stream. The process results in desalinated water and a reject sodium chloride solution.

FIG. 4 illustrates the breakthrough profile of different ions for a synthetic seawater solution passed through a cation exchange column pre-saturated in magnesium form. C₀ and C refer to the influent and effluent concentrations, respectively, for each ion. The influent solution included 460 meq/L Na⁺, 150 meq/L Mg²⁺, and 30 meq/L Ca²⁺. The cation exchange column was pre-saturated in magnesium form.

FIG. 5 is a schematic illustration of the flat leaf membrane cell apparatus for the experimental runs described in the examples below.

FIG. 6 illustrates permeate flux vs. transmembrane pressures for solutions of different compositions subjected to reverse osmosis. Solution 1 included 500 meq/L MgSO₄. Solution 2 included 250 meq/L MgSO₄ and 250 meq/L NaCl. Solution 3 included 125 meq/L MgSO₄ and 375 meq/L NaCl. Solution 4 included 500 meq/L NaCl. A SWHR 30 membrane (Dow FILMTEC) was used in the experiments.

FIG. 7 illustrates salt rejections at different transmembrane pressures for solutions containing different proportions of sodium chloride and magnesium sulfate. Solution 1 included 500 meq/L MgSO₄. Solution 2 included 250 meq/L MgSO₄ and 250 meq/L NaCl. Solution 3 included 125 meq/L MgSO₄ and 375 meq/L NaCl. Solution 4 included 500 meq/L NaCl. A SWHR 30 membrane (Dow FILMTEC) was used in the experiments.

FIG. 8A is a schematic illustration of an experimental column run described in the examples below, and FIG. 8B depicts calcium ion concentrations in the influent seawater as well as in the effluent obtained after cycles of operation.

FIG. 9 depicts the sodium and magnesium concentrations in influent seawater and in effluent obtained after cycles of operation, further described in the examples below.

### DETAILED DESCRIPTION

In a typical pressure-driven desalination process using RO or NF membrane, efficient pretreatment is a necessary and important step for ensuring long life of the membrane. Modern desalination plants often incorporate processes such as of microfiltration or ultrafiltration or combination of both, for the purpose of separation of the large-sized contaminants like suspended or colloidal particulates and large organic molecules that might be present in the feed sea or brackish water. In a pressure-driven membrane-based desalination process, while a portion of the feed water is recovered as desalinated or demineralized water for potable or industrial uses, the salts originally present in the feed water are concentrated in the reject water stream.

Moreover, due to differences in permeability between the constituent ions and water through the semi-permeable membranes, the feed side solution gets further concentrated inside a boundary layer formed at the active surface of the membrane in the feed water side through a phenomenon known as concentration polarization. As a result, some of the ions present in the feed water tend to form precipitates of their respective salts when their concentrations exceed the solubility product values of the sparingly soluble salts. Fouling of the membranes caused by the salt precipitates is of major concern as they impact to decrease the product water flux accompanied by an increase in the transmembrane pressure. Because of the relative abundance of sulfate ions in seawater, the sulfate salts of calcium, barium and strontium are significant as potential scale-forming salts. Other salts that also have significant scale-forming potential are carbonate and fluoride salts of calcium.

In order to avoid scale formation and the resulting decrease in the membrane throughput and deleterious effect on membrane life, the design and operation of a membrane-based treatment plant should consider the possibility of scale formation and therefore limit water recovery and operational practices accordingly. See, Nemeth, “Innovative system designs to optimize performance of ultra-low pressure reverse osmosis membranes,” Desalination 118, 63 (1998). Generally, RO plants use one or more methods of chemical pretreatment for preventing scale formation. Such pretreatment protocols include ion exchange softening, prior chemical precipitation to remove scale-causing cations, and use of anti-scalant chemicals. Historically, polyphosphate and organo-phosphonates were used as scale-inhibitors, although they have now been replaced by synthetic polymers like poly(acrylic acid), poly(methacrylic acid), and other proprietary chemicals. These chemicals are non-biodegradable and may pose a harm to the environment if they are discharged along with the concentrate.

The scale-inhibitors normally slow down the process of crystal formation for the precipitating salts or interfere with the crystal structures of the salts. However, as their action is dependent on kinetics and not on the equilibrium of salt formation, eventually salt formation at the membrane interfaces cannot be avoided. Thus, anti-scalants normally increase the operating time for the membranes before it is required to chemically clean the membrane. See, Hasson, et al., “Induction times induced in an RO system by antiscalants delaying CaSO₄, precipitation,” Desalination 157, 193 (2003). Intermittently, in RO plants, acidified solutions at pH 2-3 are used to remove metal oxide sand scale deposits, and alkaline solutions at pH 11-12 are used to remove silt deposits and biofilms. Additional chemicals, which are often needed, include detergents, oxidants, and chelating agents.

The foregoing chemicals are detrimental to the environment and their discharge is regulated. Normally, cleaning is carried out at regular intervals so as to avoid decline in the permeate flow rate, deterioration of permeate quality, or increase in pressure drop across the membrane. However, as a safeguard against performance decline or decrease in membrane life, conventional membrane systems usually allow for a large fraction of the feed water to be wasted as reject or concentrate, typically 20 to 30% of the feed water for brackish water and as high as 65% for seawater. This inefficiency is necessary, in part, to prevent concentrations of the ions going beyond the solubility product values, which would cause deposition of sparingly soluble compounds like sulfate salts of barium, strontium, calcium, and similar metals normally present in seawater.

Art-recognized desalination process suffers from another major handicap, namely high energy consumption and related costs to produce desalinated water. The energy requirement in reverse osmosis processes depends on the salt concentration and ranges from about 10 kJ/kg for brackish water to about 20 kJ/kg for seawater. Using the latest state of the art technology, the energy requirement is still about 8.4 kWh/1000 gallon (2.2 kWh/m³). While other costs are important, energy cost alone is the decisive factor often cited against using this desalination process. In fact, according to a recent estimate, for a reverse osmosis desalination plant, electric power constitutes 44% of the total cost of producing desalinated water, exceeding the fixed charges or capital costs, which are 37% of the total cost.

The minimum energy that is thermodynamically required for desalination of seawater containing 3.5% solution of sodium chloride due to osmotic pressure has been determined to be 0.82 kWh/m³. There have been efforts to produce new type of improved membranes and machineries so that the energy requirement is reduced, but these efforts alone can not dramatically reduce the energy consumption figure as of today.

Thus, despite being popular, current RO processes suffer from a number of drawbacks, including (1) scaling of salts on the membrane surface at the feed water-membrane interface and (2) high energy consumption per unit volume of desalinated or demineralized water produced. This invention provides a new technology that addresses these two problems.

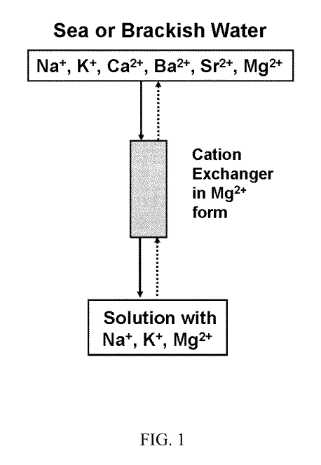

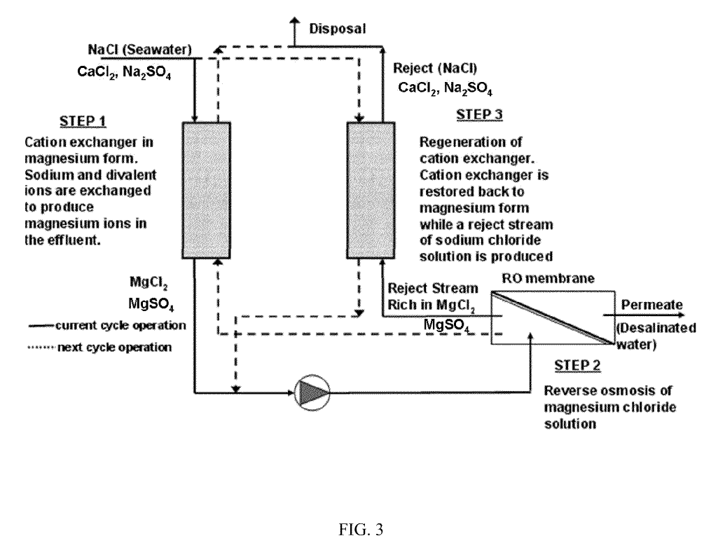

Accordingly, in one embodiment, the invention provides a method of desalination. Referring to the attached drawings, an exemplary RCIX-MEM process is illustrated in FIGS. 1 and 3, to which the following description refers. The RCIX-MEM process includes a combination of two processes, reversible cation exchange (illustrated in FIG. 1) and desalination through a pressure driven membrane process (illustrated in FIG. 3). Referring to FIG. 1, scaling-forming divalent cations of calcium (Ca²⁺), barium (Ba²⁺), and strontium (Sr²⁺) of sea or brackish water are exchanged for less scale-forming magnesium ions (Mg²⁺) through a reversible ion exchange process where a cation exchanger pre-saturated in magnesium form is contacted with the feed water. This cation exchange process also reduces the osmotic pressure of the effluent.

### Reduction in Scale-Forming Precipitates

This invention prevents fouling of the active membrane surface caused by scale deposits of inorganic salts during a membrane-based desalination process. Fouling of RO membranes caused by the precipitation of calcium, barium, and strontium salts results in the decrease of product water flux accompanied by an increase in transmembrane pressure. Many divalent cations form sparingly soluble salts with anions, such as sulfates, carbonates, fluorides, etc. Salts of magnesium, however, are considerably more soluble.

Table 1, below, lists the solubility product values of some exemplary scale-forming salts of calcium, barium, and strontium ions along with that of magnesium. Due to the relative abundance of sulfate ions, precipitation of sulfate salts is of significant concern. Not all divalent cations form precipitates with sulfate, which is present in considerably high concentrations in seawater or brackish water. Precipitation of carbonate salts is also important. However, a small swing in pH towards the acidic range can eliminate scaling of carbonate salts by converting the carbonate ions to bicarbonates, which are generally not sparingly soluble salts capable for forming scale. Except for barium fluoride, the solubility product values of magnesium salts as listed in Table 1 are several orders of magnitude higher than that of other divalent salts of calcium, barium or strontium. Therefore, the scale-forming potential of seawater or brackish water may be completely eliminated for pressure-driven membrane desalination processes, such as reverse osmosis, when scale-forming di- or higher valent cations (generally, calcium, barium, and strontium) present in the feed water to the membrane are replaced by magnesium ions.

TABLE 1
Solubility product values of some exemplary
salts under ideal condition at 25° C.

| Salt | Chemical Formula | Solubility Product (Kₛₚ) |
|---|---|---|
| Calcium Sulfate | CaSO₄ | 6.3 × 10⁻⁵ |
| Barium Sulfate | BaSO₄ | 1.08 × 10⁻¹⁰ |
| Strontium Sulfate | SrSO₄ | 2.82 × 10⁻⁷ |
| Magnesium Sulfate | MgSO₄ | 4.67 |
| Strontium Carbonate | SrCO₃ | 1.58 × 10⁻⁹ |
| Barium Carbonate | BaCO₃ | 7.94 × 10⁻⁹ |
| Calcium Carbonate | CaCO₃ | 9.77 × 10⁻⁹ |
| Magnesium Carbonate | MgCO₃ | 2.08 × 10⁻⁴ |
| Strontium Fluoride | SrF₂ | 2.82 × 10⁻⁹ |
| Calcium Fluoride | CaF₂ | 3.38 × 10⁻¹¹ |
| Barium Fluoride | BaF₂ | 1.7 × 10⁻⁶ |
| Magnesium Fluoride | MgF₂ | 7.08 × 10⁻⁹ |

In the ion exchange process, feed water is passed through a bed of cation exchange resin(s) in magnesium form where scale-forming divalent ions are replaced by magnesium ions. Such a replacement by magnesium ions may be performed in common commercial cation exchangers, in which barium, strontium, and calcium ions are preferred by the ion exchange resins compared to magnesium ions. For strong-acid cation exchangers, selectivity for scale-forming calcium, barium and strontium ions is higher compared to that of magnesium. Thus, magnesium is preferentially displaced by calcium, barium or strontium in a fixed-bed column containing cation exchanger pre-saturated in magnesium form. As a result, when seawater or brackish water is contacted with cation exchangers pre-saturated with magnesium ions, calcium, barium and strontium ions are preferentially taken up by the cation exchangers in exchange of equivalent ionic concentrations of magnesium ions, which are released into the aqueous phase.

### Reduction in Osmotic Pressure

The systems and methods described herein relate to desalination of saline solutions, specially seawater and brackish water, which principally include a high concentration of the 1-1 electrolyte sodium chloride, along with other components such as calcium, magnesium, barium, and strontium, among others, as cations. The magnesium ion exchange processes described above exchanges equivalents of ion charges. The osmotic pressure, however, is governed by molar concentrations of the ions/solutes. Replacement of ions of sodium, a monovalent cation, by divalent magnesium ions produces a concomitant reduction of the solution osmotic pressure. The reduction of osmotic pressure may be on the order of about 10%, 20%, 30%, or more. Such a combination of ion exchange and semi-permeable membrane process, wherein magnesium ions are exchanged to create a synergistic effect on reduction of fouling of the membranes and a simultaneous increase in the product water recovery, is heretofore unknown in the art. Moreover, the reduction in osmotic pressure improves transmembrane pressure, flux, desalinated water yield, and also reduces energy consumption.

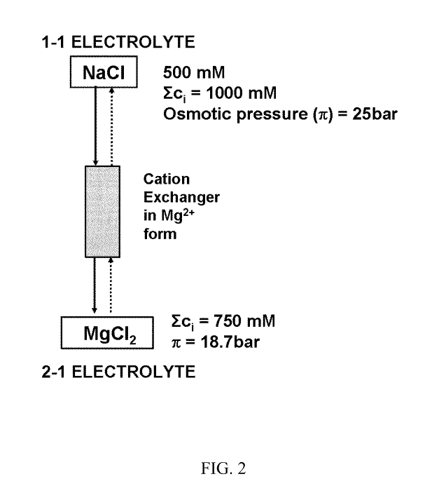

The reduction in osmotic pressure is illustrated in FIG. 2. By exchanging sodium cations in the 1-1 electrolyte NaCl with magnesium (to produce MgCl₂), the osmotic pressure of the resultant water decreases from 25 bar to 18.7 bar (a 25% reduction in osmotic pressure). Thus, the seawater or brackish water, after pretreatment through the cation exchanger pre-saturated in magnesium form, can be desalinated at a much lower transmembrane pressure compared to the conventional RO process. Also, the ion exchange process is reversible; therefore, sodium chloride can be reproduced from MgCl₂ by reversing the flow direction as shown by the dashed lines in FIG. 2. This regeneration process is discussed in detail below.

### Self-Regeneration of Desalination System

After desalination, the concentrated return from the RO process containing higher concentration of ions, having mainly magnesium and sodium as cations, may be for regeneration of the cation exchanger back to the magnesium form. This regeneration allows for the process to be self-sustainable without any need of addition of new salt or ion exchanger in the process. An example regeneration process is illustrated by the dotted line in FIG. 1. After the magnesium-enriched solution is subjected to high pressures in a reverse osmosis system, the reject solution is highly enriched with magnesium, which may be passed back through the cation exchanger to regenerate it.

### Exemplary Desalination System

An exemplary embodiment of a desalination system according to the present invention is illustrated in FIG. 3. In this embodiment, two trains or channels of cation exchange columns and one RO/NF membrane are used. In FIG. 3, the solid lines represent operation of the system in the forward direction, and the dotted lines represent operation of the system in the reverse direction. By iteratively operating the system in the forward and reverse directions, each of the two cation exchange columns is selectively either depleted with magnesium or regenerated with magnesium. The apparatus is configured iteratively to regenerate the first cation exchange column with the magnesium-enriched waste water from the second cation exchange column and vice versa (the fluid flow direction being controlled by the illustrated pump).

In a first step, incoming seawater (or brackish water or industrial wastewater) is passed through a cation exchanger in magnesium form leading to following exchange reactions:

(̅R̅S̅O̅₃̅⁻̅)̅₂̅M̅g̅²̅⁺̅+2Na⁺ [symbol] 2 (̅R̅S̅O̅₃̅⁻̅)̅N̅a̅⁺̅+Mg²⁺ (1)

(̅R̅S̅O̅₃̅⁻̅)̅₂̅M̅g̅²̅⁺̅+Ca²⁺ or Ba²⁺ [symbol] (̅R̅S̅O̅₃̅⁻̅)̅₂̅C̅a̅²̅⁺̅o̅r̅ B̅a̅²̅⁺̅+Mg²⁺ (2)

The overbar denotes the solid exchanger phase, and RSO₃⁻ represents its sulfonic acid functional group of a polymeric organic sulfonate cation exchange resin. The exchange resin is typically in the form of a packed bed within a column.

In a subsequent step, the resultant solution mainly containing magnesium and chloride ions is subjected to reverse osmosis. Because the osmotic pressure of the solution is now lower than the original seawater or brackish water and scaling or fouling potential is greatly reduced or eliminated, higher permeate flux or higher product water recovery is attainable even with lower membrane area requirement. Also, as the product water recovery is higher, the energy consumption per unit volume of product water is lower than the conventional RO process.

Next, the reject stream from the membrane, rich in magnesium, passes through the previously exhausted cation exchange column (now mostly in sodium form) from the first step. The cation exchange column is transformed back into magnesium form and the resulting effluent mostly contains NaCl (1-1 electrolyte) along with other cations like calcium, magnesium etc, and anions like sulfate, bicarbonate, etc.

2 (̅R̅S̅O̅₃̅⁻̅)̅N̅a̅⁺̅+Mg²⁺ [symbol] (̅R̅S̅O̅₃̅⁻̅)̅₂̅M̅g̅²̅⁺̅+2Na⁺ (3)

(̅R̅S̅O̅₃̅⁻̅)̅₂̅C̅a̅²̅⁺̅ o̅r̅ B̅a̅²̅⁺̅+Mg²⁺ [symbol] (̅R̅S̅O̅₃̅⁻̅)̅₂̅M̅g̅²̅⁺̅+Ca²⁺ or Ba²⁺ (4)

In this embodiment, no external regenerant is required, and the ion exchange system is again ready for operation in the first step (e.g., cation exchange of sodium, calcium, etc. for magnesium) as described above. The RCIX-MEM process is therefore self-sustaining, i.e., the cation exchangers switch back and forth between magnesium and sodium forms without needing any external regenerant. Magnesium concentration in naturally occurring seawater (˜100-120 meq/L) is usually significantly greater than that of calcium (−20-30 meq/L), thereby favoring sustainability of the process.

### EXAMPLES

### Example 1

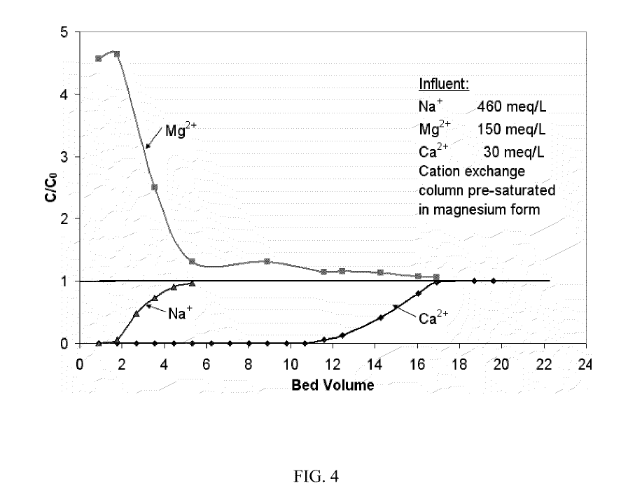

A synthetic solution representing a typical sea water composition containing 460 meq/L sodium, 30 meq/L calcium, and 150 meq/L magnesium ions as cations were passed through a cation exchange column, where the cation exchange resins (Purolite SST 60 cation exchange resins) were initially pre-saturated in magnesium form. FIG. 4 represents the breakthrough profile of different ions effluent to the column. The cation exchange column released magnesium ions in exchange with influent cations. Sodium ions broke through the column first, while calcium ions broke through the column much later. The late breakthrough of calcium compared to magnesium and sodium ions demonstrated that the cation exchanger prefer calcium compared to magnesium and sodium ions. The selectivity or preference of barium and strontium ions for common cation exchangers is much higher than that of calcium ions.

In such a RCIX-MEM process, the cation exchange step that precedes the RO step removes all the sulfate-scale-forming ions from the solution that will be fed to the RO process. The feed water to the membrane therefore principally includes sodium and magnesium ions which have very low scale-forming potential. Also, sodium ions in the feed water have been partially replaced by magnesium ions. Such a replacement causes the osmotic pressure of the resultant water feed to the RO process to considerably drop, enabling desalination to take place at a significantly lower energy compared to the conventional RO process.

### Example 2

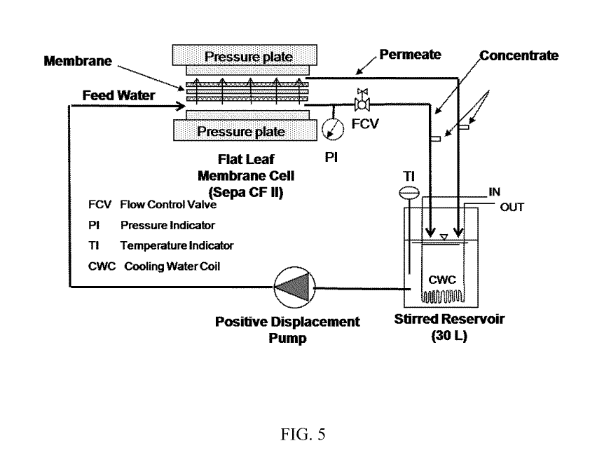

Solutions containing different concentrations of sodium chloride and magnesium sulfate but with same total electrolyte concentrations in terms of milli-equivalents per liter (meq/L) were subjected to pressure-driven RO process using the flat leaf membrane cell apparatus illustrated in FIG. 5. The permeate flux, salt concentrations in the feed and permeate, and differential feed pressures (transmembrane pressures) were monitored. The flat leaf test cell apparatus was manufactured by GE Osmonics (Model: SEPA CF II), and the reverse osmosis membrane used was manufactured by Dow Chemicals (Product name: Filmtec SWHR 30).

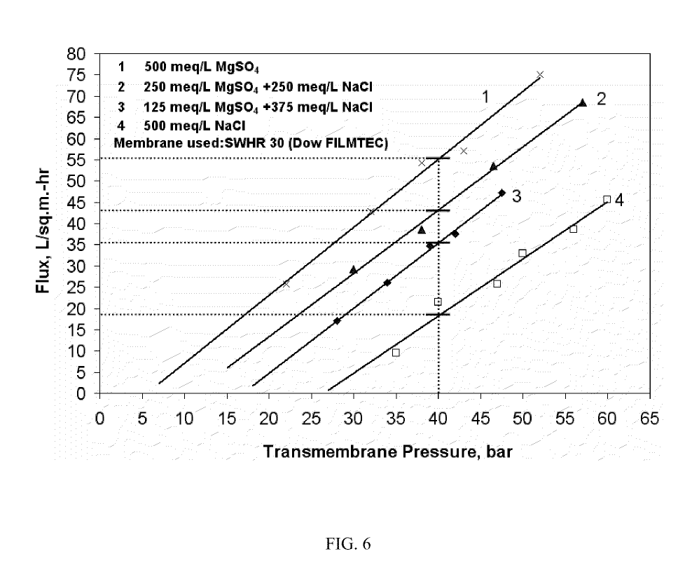

Using this apparatus, the data illustrated in FIG. 6 show the permeate flux obtained at different transmembrane pressures when solutions with different compositions of sodium chloride and magnesium sulfate but at constant ionic concentrations in meq/L basis were subjected to reverse osmosis. At same transmembrane pressures, higher flux of permeate were observed when sodium ions in the solution were replaced by magnesium ions.

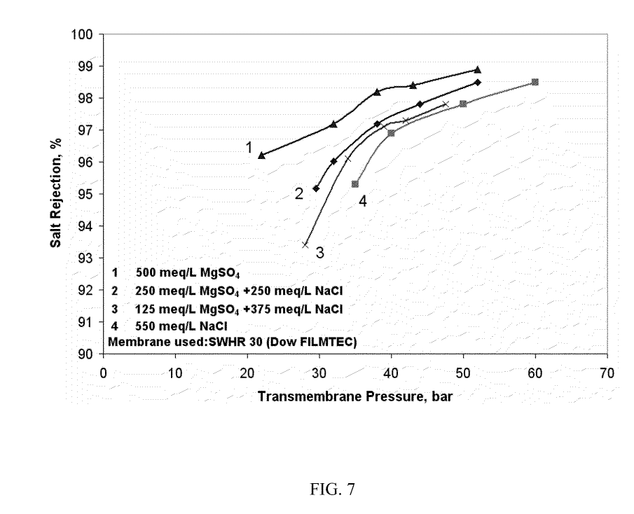

FIG. 7 represents the salt rejection characteristics of the reverse osmosis membrane for the same experiment. At same transmembrane pressure, percentage salt rejection for an RO membrane is higher for solutions containing higher proportions of magnesium ions. FIGS. 6 and 7 suggest that if sodium ions are replaced by magnesium ions, either as a whole or in part, a significant improvement in the product water flux and quality is possible for desalination using a reverse osmosis membrane. Therefore, the RCIX-MEM is a better process compared to conventional RO process, in terms of scale-free operation, energy requirements, permeate recovery, and product water quality.

### Example 3

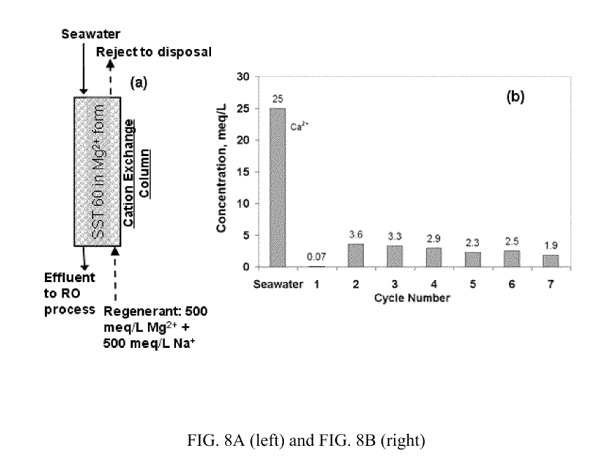

In preferred embodiments, the RCIX-MEM process is sustainable over many cycles of operation without needing any external regenerant or ion exchange resin. As discussed above, the concentrated return from the reverse osmosis step of the RCIX-MEM process may be used as a regenerant for the cation exchange column that is already exhausted from contact with saline feed water and therefore is mostly in sodium form. The concentrated return from the reverse osmosis step primarily includes sodium and magnesium ions. In order to validate the sustainability of the self-regeneration process, a cyclical run was performed according to the schematic in FIG. 8A, where seawater containing 450 meq/L sodium ions, 100 meq/L magnesium, and 25 meq/L calcium ions was fed to a column containing cation exchange resin (SST 60, Purolite Co., PA) pre-saturated in magnesium form. It was regenerated by a solution containing 500 meq/L sodium chloride and 500 meq/L magnesium chloride.

FIG. 8B shows how calcium concentration was reduced at the column exit, i.e., which is analogous to the water fed to a RO membrane. Calcium does not pose any fouling potential at such low concentrations. The same observation holds true for barium and strontium ions also. The effluent data also validate that the reject from the RO process alone can be an effective regenerant to sustain the process.

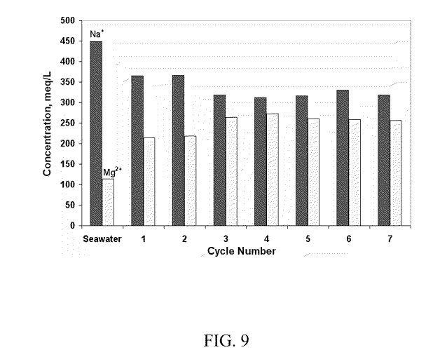

FIG. 9 indicates the sodium and magnesium ion concentrations at the effluent of the ion exchange process over number of cycles. The effluent concentration approaches a steady state after the 5^{th} cycle. Therefore, during a coupled operation of a reversible cation exchange with reverse osmosis, the system reaches a steady state after a few cycles of operation. Desalination of sea or brackish water can be accomplished without any chance of scale formation, at higher product water recovery with associated lowering of energy cost per unit of water produced.

While this description is made with reference to exemplary embodiments, it will be understood by those skilled in the art that various changes may be made and equivalents may be substituted for elements thereof without departing from the scope. In addition, many modifications may be made to adapt a particular situation or material to the teachings hereof without departing from the essential scope. Also, in the drawings and the description, there have been disclosed exemplary embodiments and, although specific terms may have been employed, they are unless otherwise stated used in a generic and descriptive sense only and not for purposes of limitation, the scope of the claims therefore not being so limited. Moreover, one skilled in the art will appreciate that certain steps of the methods discussed herein may be sequenced in alternative order or steps may be combined. Therefore, it is intended that the appended claims not be limited to the particular embodiment disclosed herein.

1. A method of desalination comprising
at least partially exchanging cations in a feed water for magnesium ions using a reversible cation exchange process to thereby produce an effluent water having a reduced concentration of scale-forming di- or higher valent cations and a reduced osmotic pressure, and thereafter
treating said effluent water from the prior step with a pressure-driven process to produce a desalinated water and a waste water.

2. The method according to claim 1, wherein said scale-forming di- or higher valent cations comprise at least one cation of calcium, barium, or strontium.

3. The method according to claim 1, wherein said cations in said feed water comprise sodium cations.

4. The method according to claim 1, wherein said feed water is seawater, brackish water, or industrial wastewater.

5. The method according to claim 1, wherein said reversible cation exchange process comprises passing said feed water through a strong-acid cation exchange resin in magnesium form.

6. The method according to claim 5, wherein said strong-acid cation exchange resin comprises a polymeric organic sulfonate and magnesium cations.

7. The method according to claim 5, wherein said cation exchange resin is in the form of a packed bed within a column.

8. The method according to claim 7, wherein said cation exchange resin is regenerated into magnesium form by contacting said resin with said waste water.

9. The method according to claim 1, wherein said pressure-driven process to produce desalinated water comprises reverse osmosis.

10. The method according to claim 1, wherein the ratio of the number of monovalent ions to divalent magnesium ions in said effluent water is higher than in said feed water.

11. The method according to claim 1, wherein the said method is employed in conjunction with a regeneration step wherein the concentrated return or reject solution from reverse osmosis or a nanofiltration membrane process is used as a regenerant to transform the cation exchanger back to magnesium form.

12. The method according to claim 1, wherein the osmotic pressure of said effluent water is at least 20% less than the osmotic pressure of said feed water.

13. A method of manufacturing desalinated water comprising
providing a strong-acid cation exchange resin in magnesium form;
contacting a feed water with said strong-acid cation exchange resin to thereby produce an effluent water, said effluent water being at least partially enriched with magnesium cations and at least partially depleted of scale-forming cations;
compressing said effluent water against a first surface of a semi-permeable filter;
collecting a desalinated water from a second surface of said semi-permeable filter, said desalinated water having passed between said first surface and said second surface while under pressure; and
collecting a waste water, said waste water having not passed between said first surface and said second surface while under pressure.

14. The method according to claim 13, wherein contacting said feed water with said strong-acid cation exchange resin forms a resin depleted of magnesium ions.

15. The method according to claim 15, further comprising a step of regenerating said resin depleted of magnesium cations with said waste water.

16. The method according to claim 13, wherein said semi-permeable filter is a reverse osmosis membrane or a nanofiltration membrane.

17. An apparatus for desalination comprising
a first cation exchange column comprising magnesium ions, the cation exchange column being disposed to contact a feed water comprising sodium cations to form an effluent water; and
a semi-permeable filter for treating said effluent water to produce a desalinated water and a waste water.

18. The apparatus according to claim 17, further comprising a second cation exchange column.

19. The apparatus according to claim 17, wherein said apparatus is configured iteratively to regenerate said first cation exchange column with said magnesium-enriched waste water from said second cation exchange column and vice versa.
